(19) United States
(12) Patent Application Publication
(10) Pub. No.: US 2026/0099361 A1
(43) Pub. Date: Apr. 9, 2026

(54) HARDWARE-AWARE THREAD SCHEDULING FOR RECOMMENDATION MODELS

(71) Applicant: ADVANCED MICRO DEVICES, INC., Santa Clara, CA (US)

(72) Inventors: Onur Kayiran, West Henrietta, NY (US); Rishabh Jain, State College, PA (US); Teyuh Alice Chou, Sunnyvale, CA (US); John Kalamatianos, Boxborough, MA (US)

(21) Appl. No.: 19/005,287

(22) Filed: Dec. 30, 2024

Related U.S. Application Data
(60) Provisional application No. 63/703,446, filed on Oct. 4, 2024.

(51) Int. Cl. G06F 9/48; G06F 9/54

(52) U.S. Cl. CPC G06F 9/4881; G06F 9/54; G06F 2209/543; G06F 2209/548

(57) ABSTRACT

To schedule threads for embedding layers of a recommendation model, a processor is configured to define queues each associated with a corresponding range of heuristic values. Further, the processor defines these queues such that each queue provides threads to certain processor cores on one or more dies. When scheduling threads for the embedding layer, the processor first determines a heuristic value of an embedding table associated with the threads. The processor then loads the threads into the queue associated with a range of heuristic values that includes the heuristic value of the embedding table. The processor then provides the threads from the queue to one or more processor cores associated with the queue.

### BACKGROUND

To recommend products or services to a user based on a user's interests, certain processing systems implement a recommendation model that generates personalized recommendations for the user. As an example, a processing system implements a recommendation model configured to receive data associated with the user and data indicating a catalogue of products and services as inputs and provide one or more recommendations for the user as an output. When implementing this recommendation model, the processing system is configured to map the data associated with the user and the data identifying one or more producers or services to corresponding embedding vectors. The processing system then performs various compute operations, such as matrix compute operations and vector compute operations, using the embedding vectors to generate one or more recommendations identifying a certain product or service to recommend to the user.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system including a processor configured to implement hardware-aware thread scheduling for recommendation models, in accordance with some embodiments.

FIG. 2 is a flow diagram of an example operation for hardware-aware thread scheduling to execute threads for embedding layers of a recommendation model, in accordance with some embodiments.

FIG. 3 is a block diagram of an example architecture for hardware-aware thread scheduling, in accordance with some embodiments.

FIG. 4 is a flow diagram of a method for hardware-aware thread scheduling to execute threads for embedding layers of a recommendation model, in accordance with some embodiments.

### DETAILED DESCRIPTION

Systems and techniques disclosed herein include a processing system configured to recommend certain products or services from a catalogue of products or services to a user based on the interests of the user. For example, the processing system is configured to collect or receive user data associated with the user that represents the user's previous interactions with an application (e.g., streaming application, store application, chat application, review application), the occupation of the user, gender of the user, hobbies of the user, social media posts of the user, historical or current locations of the user, or the like. Using this user data, the processing system then selects one or more products or services from a catalogue to recommend to the user. As an example, the processing system implements one or more recommendation models configured to receive the user data and a catalogue of products or services as inputs and provide a recommendation that identifies a product or service from the catalogue as an output. These recommendation models include, for example, one or more deep-learning recommendation models (DLRMs) such as neural collaborative filtering models, autoencoder-based recommendation models, deep matrix factorization models, recurrent neural networks, or any combination thereof, to name a few. When implementing a recommendation model to generate a recommendation for a user, the processing system first provides data representing the user data and a set of products or services (also referred to herein as a “catalogue”) to one or more embedding layers of the recommendation model. These embedding layers are each configured to map the user data to corresponding vectors (e.g., embeddings) that include values representing the user data and to map the products and services indicated in the catalogue to corresponding vectors (e.g., embeddings) that include values representing the products and services. As an example, the embedding layer maps one or more previous interactions with an application indicated in the user data to one or more corresponding vectors. As another example, the embedding layer maps the hobbies of the user to one or more corresponding vectors.

When mapping the user data and the products and services from a catalogue to corresponding vectors, the embedding layer is configured to use one or more embedding tables that include data mapping certain attributes (e.g., user's previous interactions with an application, the occupation of the user, gender of the user, hobbies of the user, social media posts of the user, historical or current locations of the user) indicated in the user data to corresponding vectors and certain products and services indicated in the catalogue to corresponding vectors. For example, to map an attribute of user data, a product, or a service to a corresponding vector (e.g., embedding vector), the embedding layer first determines one or more offsets based on the attribute of the user data, product, or service. The embedding layer then uses these determined offsets to identify one or more locations (e.g., address) within one or more corresponding embedding tables that store data indicating an embedding vector corresponding to the attribute of the user data, product, or service. Further, to implement the embedding layer of a recommendation model, the processing system includes a processor (e.g., central processing unit (CPU), accelerated unit (AU)) configured to execute threads that perform a lookup of data (e.g., certain embedding vectors) in the embedding tables. As an example, these threads include instructions that, when executed, cause the processor to generate one or more offsets based on data representing a certain attribute of the user data, a certain product, or a certain service. Using these offsets, the processor looks up a corresponding embedding vector associated with the attribute of the user data, product, or service in one or more embedding tables. Such threads that look up certain embedding vectors from corresponding embedding tables are also referred to herein as “embedding table threads.”

To execute these embedding table threads, the processor includes one or more dies each having one or more processor cores configured to execute one or more threads (e.g., concurrently execute two or more threads). Further, the processor implements one or more scheduling operations that schedule the embedding table threads at corresponding processor cores, corresponding dies, or both for execution. As an example, while implementing such scheduling operations, the processor is configured to schedule embedding table threads for execution at one or more processors across one or more dies based on one or more determined heuristics of the embedding tables of the recommendation model. To this end, the processor or a processing unit of a computing device connected to the processor is configured to first determine a respective time value heuristic for each embedding table associated with the recommendation model. That is to say, the processor or other processing unit determines a corresponding time value heuristic for each embedding table that one or more embedding table threads are to perform lookups in. Such a time value heuristic, for example, indicates the amount of processing work required per embedding table. The processor or other processing unit is configured to determine a time value heuristic based on the pooling factor (e.g., a factor indicating compute data and data movement for the embedding table) and an average memory access latency (AMAL) for the embedding table using profile data. As an example, the processor or other processing unit determines the product of the pooling factor and AMAL of an embedding table to determine a time value heuristic for the embedding table.

After determining a time value heuristic for each embedding table, the processor or other processing unit determines a corresponding memory level parallelism heuristic (MLPH) for each of the embedding tables based on the determined time heuristic values. This MLPH, for example, represents a weighted memory level parallelism for a corresponding embedding table. That is to say, the MLPH for an embedding table indicates a weighted level of memory traffic for the embedding table (e.g., for the threads associated with the embedding table). To determine an MLPH for an embedding table, the processor or other processing unit first determines a cache miss ratio (e.g., L3 cache miss ratio) for the embedding table based on a reuse distance profile generated when processing the embedding table (e.g., based on profile data generated while determining the AMAL of the embedding table). The processor or other processing unit then multiplies the cache miss ratio of the embedding table by the time value heuristic of the embedding table to determine the MLPH for the embedding table. Additionally, after determining a corresponding MLPH for each embedding table, for example, the processor or other processing unit is configured to determine a core grouping for each embedding table based on the MLPH of the embedding table. This core grouping, for example, includes profile-generated data indicating the maximum number of processor cores that are to execute the threads associated with the embedding table so as to help the processing system meet one or more desired metrics (e.g., memory bandwidth, processing time, memory accesses).

After an MLPH, core grouping, or both has been determined for each embedding table, the processor schedules sets of embedding table threads (e.g., groups of embedding table threads that perform lookups in the same embedding table) for execution based on the MLPHs, core groupings, or both of the embedding tables associated with the sets of embedding table threads. For example, to schedule embedding table threads based on MLPHs, core groupings, or both, the processor defines two or more queues (e.g., software queues) each configured to store one or more sets of embedding table threads. Each of these defined queues, for example, is also configured to provide embedding table threads to one or more certain processor cores of one or more certain dies. As an example, the processor is configured to define a first queue configured to provide embedding table threads to one certain processor core of one or more dies and a second queue configured to provide embedding table threads to three certain processor cores of one or more dies. Further, each queue is associated with embedding tables that have a range of one or more MLPH values (e.g., a range of memory-level parallelism heuristic values). As an example, a first queue is associated with embedding tables of MLPH values under or equal to a certain threshold value and a second queue is associated with embedding tables of MLPH values over a certain threshold value. As another example, a first queue is associated with embedding tables of MLPH values in a first range including values under a first threshold value, a second queue is associated with embedding tables of MLPH values in a second range including values between the first threshold value and a second threshold value, and a third queue is associated with embedding tables of MLPH values in a third range including values over the second threshold value.

To schedule a set of embedding table threads associated with an embedding table, the processor is configured to load the set of embedding table threads into a queue based on the MLPH value of the embedding table. For example, the processor loads the set of embedding table threads into the queue associated with the range of MLPH values that includes the MLPH of the embedding table that corresponds to the set of embedding table threads. From this queue, the processor then schedules a number of threads from the set of threads associated with the embedding table to one or more processor cores of one or more dies based on the core grouping of the embedding table (e.g., to a number of processor cores equal to a number of processor cores indicated in the core grouping). In this way, the processor is configured to schedule embedding table threads based on both the pooling factor and AMAL of embedding tables which helps increase the accuracy in estimating the amount of work (e.g., time) needed for each embedding table. Due to this increased accuracy in estimating the amount of work (e.g., time) needed for each embedding table, the processor is enabled to better balance the embedding table threads between the processor cores and dies which helps to decrease the time needed to perform the embedding layer of the recommendation model. For example, by storing the embedding table threads into queues based on MLPH ranges, the processor is enabled to distribute the work required by an embedding table to sets of processor cores that best utilize their MLP resources, which balances the distribution of work and decreases the time needed to perform the embedding layer of the recommendation model.

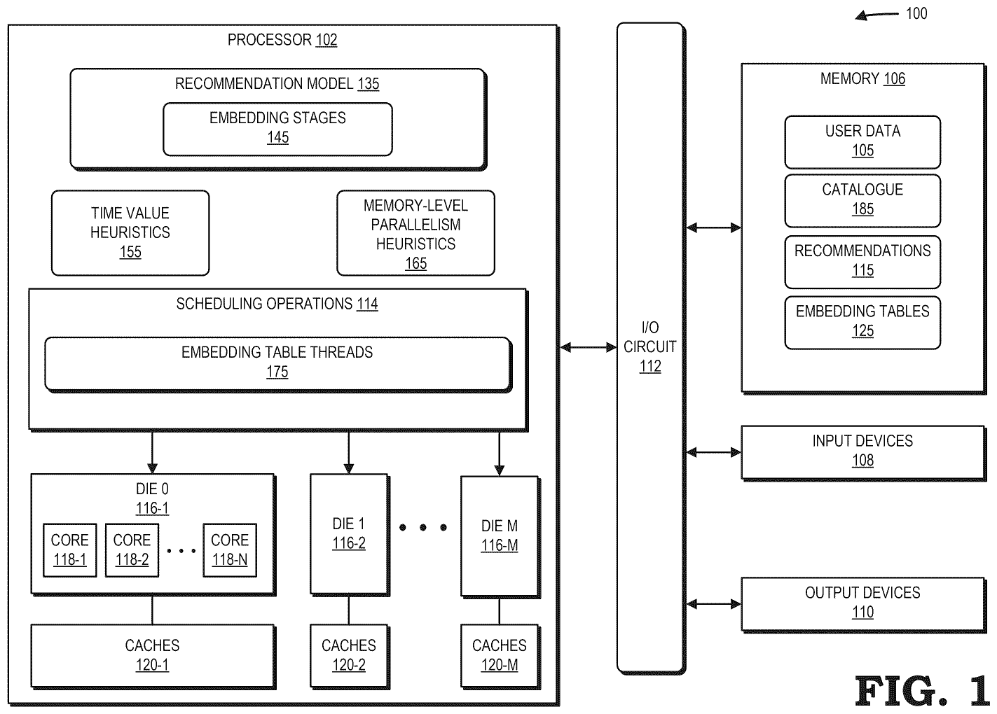

Referring now to FIG. 1, a processing system 100 including a processor configured to implement hardware-aware thread scheduling for recommendation models is presented, in accordance with embodiments. In embodiments, the processing system 100 is configured to execute one or more applications configured to present one or more recommendations 115 to a user. These recommendations 115, for example, include data indicating certain products or services from a catalogue 185 to recommend to a user via one or more output devices 110. As an example, in some embodiments, the processing system 100 is configured to execute an application that presents one or more recommendations 115 to a user as one or more images, videos, textual descriptions, links, or the like to a user using one or more output devices 110. These output devices 110, for example, are configured to output audio, video, movement, or the like associated with a recommendation 115 and include one or more speakers, motors, displays, lights, buzzers, or any combination thereof, to name a few. To determine recommendations 115 for a user, the processing system 100 is configured to implement one or more recommendation models 135 configured to generate one or more recommendations 115 based on user data 105 and data indicating a catalogue 185 (e.g., a set of one or more products, services, or both). As an example, a recommendation model 135 includes one or more DLRMs such as neural collaborative filtering models, autoencoder-based recommendation models, deep matrix factorization models, recurrent neural networks, or any combination thereof configured to generate one or more recommendations 115 based on user data 105 and a catalogue 185. The user data 105, for example, indicates information associated with one or more users. As an example, user data 105 indicates previous interactions with an application (e.g., streaming application, store application, chat application, review application) by one or more users, the occupation of one or more users, gender of one or more users, hobbies of one or more users, social media posts of one or more users, historical or current locations of one or more users, or any combination thereof. According to some embodiments, at least a portion of user data 105 is received by one or more input devices 108. These input devices 108, for example, include one or more keyboards, mice, touchscreens, headsets, controllers, joysticks, gamepads, microphones, or the like.

In embodiments, to implement a recommendation model 135, processing system 100 includes processor 102 configured to perform one or more instructions, operations, or both for a recommendation model 135. In some embodiments, processor 102 includes a CPU, AU, or both. As an example, according to some embodiments, processor 102 includes an AU that operates as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof. In embodiments, processor 102 is configured to execute one or more instructions for a recommendation model 135. For example, processor 102 is configured to execute one or more embedding table threads 175 that perform lookups in corresponding embedding tables 125. To execute these embedding table threads 175, the processor 102 includes one or more dies 116 (e.g., compute core dies) each including one or more processor cores 118 disposed thereon. One or more of these processor cores 118, for example, operate as one or more compute units each configured to execute one or more embedding table threads 175 for a recommendation model 135. For example, each compute unit includes one or more single instruction, multiple data (SIMD) units that have one or more registers, buffers, arithmetic logic units (ALUs), or any combination thereof configured to execute the operations (e.g., matrix operations, vector operations) indicated in a embedding table thread 175 of a recommendation model 135. Though the example embodiment presented in FIG. 1 shows processor 102 as including three dies (116-1, 116-2, 116-M) representing an M integer number of dies, in other embodiments, processor 102 includes any non-zero integer number of dies 116. Further, though the example embodiment presented in FIG. 1 shows a die 116-1 as including three processor cores 118 representing an N integer number of processor cores 118, in other embodiments, each die 116 can include any non-zero integer number of processor cores 118. For example, in some embodiments two or more dies 116 have the same number of processor cores 118, two or more dies 116 have a different number of processor cores 118, or both. According to some embodiments, one or more dies 116 forms one or more processing units (e.g., CPUs, GPUs, accelerator units (AU).

Further, each processor core 118 includes or is otherwise connected to one or more caches 120 configured to store data used in or resulting from the execution of one or more threads by the processor core 118. These caches 120, for example, include one or more private caches (e.g., caches only accessible by one processor core 118), shared caches (e.g., caches accessible by two or more processor cores 118), or both. As an example, one or more caches 120 form a cache hierarchy that includes hierarchically arranged levels each having caches of different sizes. As an example, a processor core 118 includes or is otherwise connected to a cache hierarchy that includes a first level with a private cache, a second level with a shared cache larger than the private cache of the first level, and a third level with a shared cache (e.g., L3) larger than the shared cache of the second level. Though the example embodiment presented in FIG. 1 shows each die 116 as including or otherwise connected to a corresponding set of caches (120-1, 120-2, 120-M), in other embodiments, each processor core 118 of each die 116 can include or otherwise be connected to any non-zero integer number of caches 120.

According to embodiments, a recommendation model 135 implemented by processing system 100 is configured to receive user data 105 associated with a user and data representing catalogue 185 as inputs and provide a recommendation 115 for the user as an output. For example, a recommendation model 135 includes one or more embedding layers 145 configured to embed user data 105 and catalogue 185 provided to the recommendation model 135 as inputs. That is to say, during the embedding layers 145, the processing system 100 is configured to map the input user data 105 and the input catalogue 185 to corresponding embeddings (e.g., vectors). As an example, during an embedding layer 145, the processing system 100 is configured to map one or more certain products, services, or both from the input catalogue 185 to corresponding embeddings. As another example, during an embedding layer 145, the processing system 100 is configured to map one or more certain attributes (e.g., one or more certain interactions with an application, occupations, genders, hobbies, social media posts, historical locations, current locations) indicated in the input user data 105 to corresponding embeddings. According to embodiments, an embedding layer 145 includes the use of one or embedding tables 125 to map attributes from the user data 105 and products, services, or both from the catalogue 185 to corresponding embeddings. An embedding table 125, for example, includes a homogenous dataset or heterogenous dataset indicating embedding vectors that each correspond to certain attributes of user data 105, certain products, certain services, or any combination thereof. As an example, to map a certain attribute of user data 105, a certain product, or a certain service to a corresponding vector (e.g., embedding vector), an embedding layer 145 first includes processing system 100 determining one or more offsets based on the attribute of user data 105, the product, or the service. The processing system 100 then uses these determined offsets to determine one or more locations (e.g., address) within one or more corresponding embedding tables 125 that store data indicating corresponding embedding vectors.

To implement the embedding layers 145 of a recommendation model 135, the processing system 100 includes or has access to a memory 106 or other storage component implemented using a non-transitory computer-readable medium, for example, a dynamic random-access memory (DRAM), that stores data associated with the recommendation model 135 such as one or more embedding tables 125. In some embodiments, the memory 106 is implemented using other types of memory including, for example, static random-access memory (SRAM), nonvolatile RAM, and the like. Additionally, to implement the embedding layers 145 of a recommendation model 135, processor 102 is configured to execute one or more threads for the embedding layers 145 (represented in FIG. 1 as “embedding table threads 175”) using the processor cores 118 of one or more dies 116. As an example, processor 102 implements one or more scheduling operations 114 during which processor 102 schedules the embedding table threads 175 for execution at corresponding processor cores 118 of one or more dies 116 (e.g., corresponding compute units of one or more dies 116). According to embodiments, scheduling operations 114 include processor 102 scheduling sets of embedding table threads 175 that each include embedding table threads 175 that perform a lookup in the same embedding table 125. That is to say, processor 102 schedules sets of embedding table threads each associated with a corresponding embedding table 125. Such embedding table threads 175, when executed, cause one or more processor cores 118 to look up certain addresses within a corresponding embedding table 125 based on user data 105, data representing one or more products or services from catalogue 185, or both. Based on executing one or more embedding table threads 175 (e.g., a set of embedding table threads 175), processor 102 identifies one or more embedding vectors and generates one or more recommendations 115 based on the embedding vectors. For example, one or more embedding table threads 175, when executed, cause one or more processor cores 118 to lookup certain addresses within a corresponding embedding table 125 by first generating one or more offsets based on user data 105, data representing one or more products or services from a catalogue 185, or both. The processor cores 118 then use these offsets to determine certain addresses within the corresponding embedding table 125 that indicate corresponding embedding vectors. After identifying these embedding vectors, the processor cores 118 generate one or more recommendations 115 using the embedding vectors according to the recommendation model 135.

In embodiments, processor 102 is configured to schedule one or more embedding table threads 175 for execution at the processor cores 118 based on the amount of work associated with the embedding table 125 corresponding to the embedding table threads 175. That is to say, based on the amount of processing time and processing resources needed to perform lookups in the embedding table 125 corresponding to the embedding table threads 175. To determine the amount of work associated with a corresponding embedding table 125, processor 102 or another processing unit of a computing device (e.g., server, desktop computer, laptop computer) connected (e.g., via a network, internet, or the like) to processor 102 is configured to determine one or more heuristics for the embedding table 125 such as a time value heuristic 155 and an MLPH 165. According to embodiments, processor 102 or another processing unit first determines a time value heuristic 155 for one or more embedding tables 125 associated with the recommendation model 135 based on a pooling factor and average memory access latency (AMAL) associated with the embedding tables 125. For example, processor 102 or another processing unit performs one or more inference batches for the recommendation model 135 wherein processor 102 or another processing unit generates (e.g., infers) one or more recommendations 115 from user data 105 and a catalogue 185. During these inference batches processor 102 or another processing unit determines a pooling factor for each embedding table 125 by profiling the user pooling operations of the inference batches. Further, during a first interference batch, processor 102 or another processing unit uses table row indices of the embedding tables 125 as proxies for actual load addresses and collects a trace for all touched (e.g., accessed) row indices across all the embedding tables 125 associated with the recommendation model 135. During one or more subsequent inference batches, processor 102 or another processing unit then tracks the number of unique row indices touched in between two instances of the same row index of an embedding table 125 while removing duplicates.

Further, for each embedding table 125, processor 102 or another processing unit estimates a reuse distance based on the tracked number of unique row indices touched in between two instances of the same row index. Processor 102 or another processing unit then determines an average memory access latency (AMAL) for each embedding table 125 based on the estimated reuse distance for the embedding table 125. As an example, for an embedding table 125, processor 102 or another processing unit first estimates a number of hits and misses to a cache 120 of a processor core 118 used to perform a lookup in the embedding table 125 based on the reuse distance and size of the embedding vectors of the embedding table 125. Processor 102 or another processing unit then determines an AMAL for the embedding table 125 based on a comparison of the estimated hits to misses. According to embodiments, after determining a pooling factor and AMAL for an embedding table 125, processor 102 or another processing unit determines a time value heuristic 155 for the embedding table 125 according to the following equation:

$${H}_{TV} = PF * ( avg MAL ) \qquad [ EQ1 ]$$

wherein H_{TV} represents the time value heuristic 155 for an embedding table 125, PF represents a pooling factor for the embedding table 125, and avg MAL represents the AMAL for the embedding table 125. By determining the time value heuristic 155 for an embedding table 125 in this way, the time value heuristic 155 represents the amount of work associated with the embedding table 125 as a function of the pooling factor and AMAL.

According to embodiments, after determining the time value heuristics 155 for the embedding tables 125 associated with the recommendation model 135 processor 102 or another processing unit is configured to determine a corresponding MLPH 165 for each embedding table 125. Such an MLPH 165, for example, represents a weighted level of memory traffic required for a corresponding embedding table 125. Processor 102 or another processing unit is configured to determine this MLPH 165 for an embedding table 125 based on the time value heuristic 155 of the embedding table 125 and a cache miss ratio (e.g., L3 miss ratio) of a cache 120 of a processor core 118 using the embedding table 125 during the inference batches. As an example, processor 102 or another processing unit first estimates a cache miss ratio (e.g., ratio of misses to accesses) for an embedding table 125 based on the determined reuse distance for the embedding table 125. Processor 102 or another processing unit then determines the MLPH 165 for the embedding table 125 based on the following equation:

$${H}_{MLP} = {H}_{TV} * {c}_{MR} \qquad [ EQ2 ]$$

wherein H_{MLP} represents the MLPH 165 for the embedding table 125, H_{TV} represents the time value heuristic 155 for the embedding table 125, and C_{MR} represents the estimated cache miss ratio for the embedding table 125.

After determining the MLPHs 165 for the embedding tables 125, in some embodiments, processor 102 or another processing unit is configured to determine a corresponding core grouping for each embedding table 125 based on the MLPH 165 of the embedding table 125. A core grouping, for example, includes data indicating a number of cores to be used to execute the embedding table threads 175 associated with that embedding table 125. As an example, processor 102 or another processing unit maps the MLPH 165 of an embedding table 125 to a corresponding core group based on data stored in, for example, memory 106. After determining a core grouping for an embedding table 125, data (e.g., metadata, flag) representing the core grouping is included in the embedding table 125, the embedding table threads 175 associated with the embedding table 125, or both. Further, in embodiments, when implementing one or more scheduling operations 114, processor 102 is configured to schedule the embedding table threads 175 for execution at one or more processor cores 118 of one or more dies based on the MLPHs 165 of the embedding tables 125 associated with the embedding table threads 175. As an example, in some embodiments, processor 102 is configured to define two or more queues (e.g., software queues) each configured to store embedding table threads 175 for execution and each associated with a discrete range of MLPH values (e.g., range of memory-level parallelism heuristic values). For example, processor 102 is configured to define a first queue associated with a first range including values less than a first threshold value (e.g., non-inclusive of the first threshold value), a second queue associated with a second range having values between the first threshold value (e.g., inclusive of the first threshold value) and a second threshold value (e.g., non-inclusive of the second threshold value), and a third queue associated with a third range including values greater than the second threshold value (e.g., inclusive of the second threshold value). Additionally, processor 102 is configured to define each queue such that each queue is configured to provide embedding table threads 175 to certain processor cores 118 of one or more certain dies 116. As an example, processor 102 defines a first queue configured to provide embedding table threads 175 to processor cores 118-1 and 118-2 of die 0 116-1 and two certain processor cores 118 of each other die 116. As another example, processor 102 defines a second queue configured to provide threads to processor core 118-N of die 0 116-1 and one certain processor core 118 of each other die 116.

To schedule one or more embedding table threads 175 associated with an embedding table 125 (e.g., a set of embedding table threads 175 that access the same embedding table 125) for execution, processor 102 determines the MLPH 165 of the corresponding embedding table 125. Processor 102 then stores the embedding table threads 175 in the queue associated with the range in which the MLPH 165 of the embedding table 125 associated with the embedding table threads 175 falls. That is to say, processor 102 selects the queue associated with the range that includes the MLPH 165 of the corresponding embedding table 125. From the queue, the processor 102 provides the embedding table threads 175 to one or more of the processor cores 118 to which the queue is configured to provide embedding table threads 175. As an example, from a queue, processor 102 provides the embedding table threads 175 to a number of processor cores 118 the queue is configured to provide to based on the core grouping of the embedding table 125 associated with the corresponding embedding table 125 (e.g., a number of processor cores 118 equal to the number of processor cores indicated in the core grouping). As another example, from a queue, processor 102 provides the embedding table threads 175 to one or more available processor cores 118 that the queue is configured to provide to (e.g., regardless of a core grouping). In this way, processor 102 is configured to schedule embedding table threads 175 based on both the pooling factor and AMAL of the embedding tables 125 associated with the embedding table threads 175. That is to say, processor 102 is configured to use both the pooling factor and AMAL to estimate the amount of work per embedding table 125. By using both the pooling factor and AMAL to estimate the amount of work per embedding table 125, the accuracy of this estimation is improved when compared to systems that do not consider the AMAL of the embedding table 125. Due to this increased accuracy in the estimation, processor 102 is enabled to better balance the threads of the embedding table threads 175 between the processor cores 118 and dies 116 of the processor 102 which helps to decrease the time needed to perform the embedding layer 145 of a recommendation model 135.

In some embodiments, to enable communication between processor 102 and one or more other components (e.g., memory 106, input devices 108, output devices 110) of processing system 100, processing system 100 includes input/output (I/O) circuit 112. I/O circuit 112 includes, for example, one or more busses, memory controllers, switches (e.g., PCI switches), data fabrics, queues, buffers, or the like. As an example, I/O circuit 112 is configured to connect one or more processor cores 118 of processor 102 to memory 106, input devices 108, output devices 110, or any combination thereof.

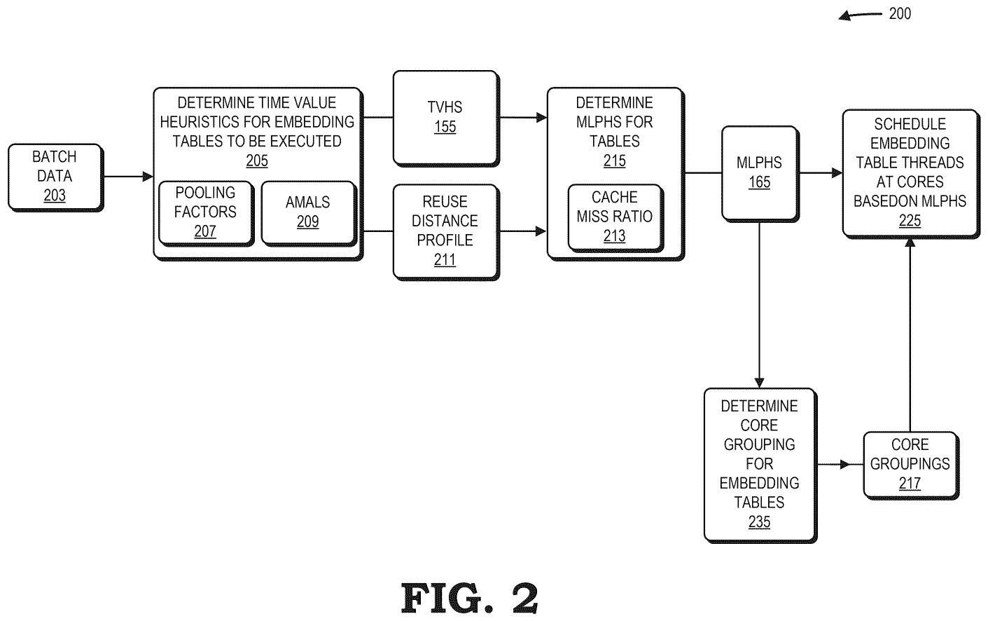

Referring now to FIG. 2, an example operation 200 for hardware-aware thread scheduling is presented, in accordance with embodiments. In embodiments, example operation 200 is implemented at least in part by processor 102 or another processing unit (e.g., a processing of a computing device connected to processor 102) to schedule embedding table threads 175 for execution. As an example, example operation 200 includes, at block 205, processor 102 (e.g., one or more processor cores 118 or one or more dies 116) or another computing device is configured to determine time value heuristics 155 for each embedding table 125 associated with a recommendation model 135. In embodiments, to determine these time value heuristics 155, processor 102 or another processing unit of a computing device connected to processor 102 first performs one or more inference batches for the recommendation model 135 wherein processor 102 or another processing unit generates (e.g., infers) one or more recommendations 115 from user data 105 and data representing a catalogue 185 using the embedding tables 125. During these inference batches, processor 102 or another processing unit is configured to monitor the user pooling operations associated with each embedding table 125 and generate a corresponding pooling factor 207 for each embedding table 125 based on the monitored user pooling operations for the embedding table 125. Additionally, based on the performance of these inference batches, processor 102 or another processing unit is configured to generate batch data 203 that indicates the accessed row indices of the embedding tables 125 during the inference batches. As an example, during a first interference batch, processor 102 or another processing unit uses table row indices of the embedding tables 125 as proxies for actual load addresses and generates batch data 203 indicating all touched (e.g., accessed) row indices across all the embedding tables 125. Further, during one or more subsequent inference batches, processor 102 or another processing unit generates batch data 203 indicating the number of unique row indices touched in between two instances of the same row index of an embedding table 125.

Still referring to block 205, after determining the batch data 203, processor 102 or another processing unit generates a reuse distance profile 211 for each embedding table 125 based on the batch data 203, size of the embedding vectors in the embedding table 125, or both. As an example, using the number of unique row indices touched in between two instances of the same row index of an embedding table 125 as indicated by the batch data 203, processor 102 or another processing unit estimates a reuse distance for the embedding table 125. Based on this estimated reuse distance, processor 102 or another processing unit determines an estimated number of hits to a cache 120 (e.g., L3 cache) used by a processor core 118 to perform a lookup in the embedding table 125 and an estimated number of misses to the cache 120 used by the processor core 118 to perform a lookup in the embedding table 125. Processor 102 or another processing unit then generates a corresponding reuse distance profile 211 for the embedding table 125 indicating the estimated reuse distance, estimated number of hits to a cache 120, estimated number of misses to the cache 120, or any combination thereof associated with the embedding table 125. According to embodiments, processor 102 or another processing unit is configured to generate a corresponding time value heuristic 155 for each embedding table 125 based on the pooling factor 207 and the reuse distance profile 211 associated with the embedding table 125. For example, using the reuse distance profile 211 for an embedding table 125, processor 102 or another processing unit first determines an AMAL 209 for the embedding table by comparing the estimated hits to a cache 120 and estimated misses to a cache 120 indicated in the reuse distance profile 211 of the embedding table 125. That is to say, processor 102 or another processing unit generates an AMAL 209 representing a ratio of the estimated hits to a cache 120 to the estimated misses to the cache 120 based on a reuse distance profile 211. Processor 102 or another processing unit then determines the time value heuristic 155 for the embedding table 125 based on the pooling factor 207 and AMAL 209 of the embedding table 125. For example, processor 102 or another processing unit multiplies the pooling factor 207 and AMAL 209 of the embedding table 125 to determine the time value heuristic 155 of the embedding table 125.

After determining a time value heuristic 155 for one or more embedding tables 125, at block 215, processor 102 or another processing unit determines a corresponding MLPH 165 for one or more embedding tables 125. At block 215, to determine an MLPH for an embedding table 125, processor 102 or another processing unit first determines a cache miss ratio 213 for the embedding table 125 based on the reuse distance profile 211 of the embedding table 125. As an example, processor 102 or another processing unit determines a cache miss ratio 213 indicating a number of misses to a cache 120 (e.g., L3 cache) to a total number of accesses (e.g., sum of the estimated number of hits and estimated number of misses) to the cache 120 based on the estimated number of hits to the cache 120 and estimated number of misses to the cache 120 indicated in the reuse distance profile 211 of the embedding table 125. Processor 102 or another processing unit then determines the MLPH 165 for the embedding table 125 based on the cache miss ratio 213 and time value heuristic 155 of the embedding table 125. For example, processor 102 or another processing unit multiplies the cache miss ratio 213 of the embedding table 125 by the time value heuristic 155 of the embedding table 125 to determine the MLPH 165 of the embedding table 125. In embodiments, after determining a corresponding MLPH 165 for one or more embedding tables 125, at block 235, processor 102 or another processing unit is configured to determine a respective core grouping 217 for one or more embedding tables 125. As an example, based on the MLPH 165 of an embedding table 125, processor 102 or another processing unit determines a core grouping 217 indicating a number of processor cores 118 with which to execute the embedding table threads 175 associated with the embedding table 125 so as to help processing system 100 achieve one or more desired metrics (e.g., memory bandwidth, processing time, memory accesses). After determining a core grouping 217 for an embedding table 125, processor 102 or another processing unit includes the core grouping 217 in the embedding table 125 as metadata, a flag, or both.

At block 225, processor 102 is configured to schedule one or more embedding table threads 175 (e.g., a set of embedding table threads 175 each associated with the same embedding table 125) for execution based on the MLPHs 165, core groupings 217, or both of the embedding tables 125 associated with the embedding table threads 175. For example, to schedule one or more embedding table threads 175 for execution at one or more processor cores 118 of one or more dies 116, processor 102 first determines the MLPH 165 of the embedding table 125 associated with the embedding table threads 175. Processor 102 then loads the embedding table threads into a queue (e.g., software queue) defined by the processor 102 that is associated with a range that includes the MLPH 165 of the corresponding embedding table 125 and, for example, does not load embedding table threads into a queue associated with a range that does not include the MLPH 165 of the corresponding embedding table 125. From the queue, processor 102 then provides the embedding table threads 175 to one or more processor cores 118 of one or more dies 116 to which the queue (e.g., as defined by processor 102) is configured to provide embedding table threads 175. As an example, based on the core grouping 217 of the associated embedding table 125, processor 102 provides the embedding table threads 175 to a number of processor cores 118 across one or more dies 116 (e.g., across two or more dies 116) indicated in the core grouping 217. As another example, processor 102 provides the embedding table threads 175 to a number of available processor cores 118 across one or more dies 116. Processor 102 then identifies one or more embedding vectors based on the execution of the embedding table threads 175 and generates one or more recommendations 115 based on the embedding vectors (e.g., according to the recommendation model 135).

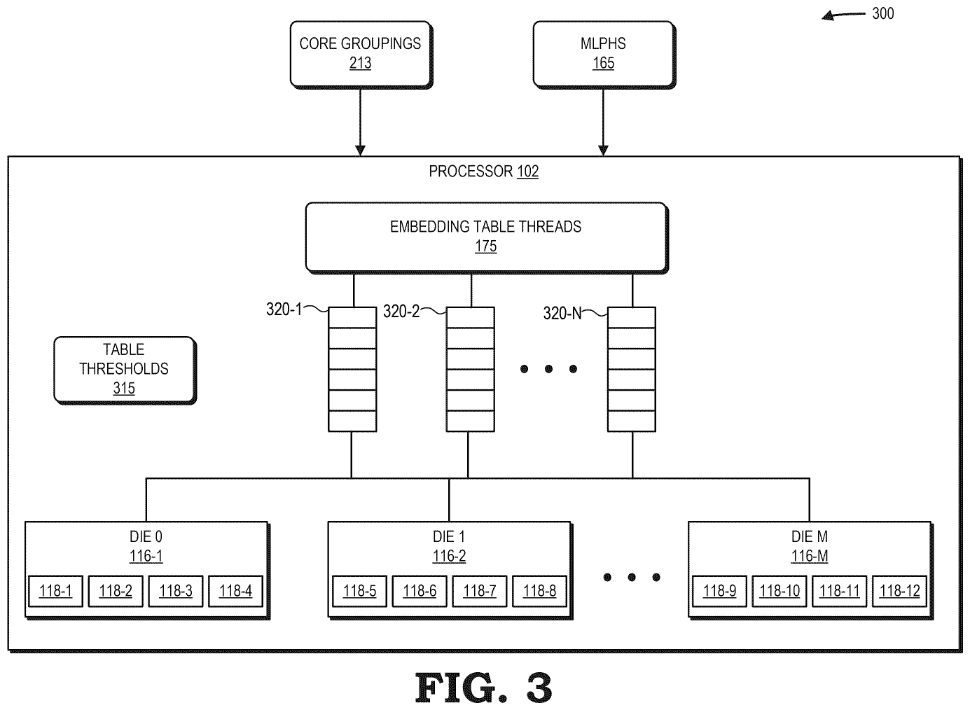

Referring now to FIG. 3, an example architecture 300 for hardware-aware thread scheduling is presented, in accordance with some embodiments. In embodiments, example architecture is implemented by processor 102 to schedule one or more embedding table threads 175. Example architecture 300 includes, for example, processor 102 defining one or more queues 320 (e.g., software queues) each associated with a corresponding range of MLPH values as defined by one or more table thresholds 315. That is to say, processor 102 defines one or more software queues each associated with embedding tables 125 of a corresponding range of MLPH values as defined by one or more table thresholds 315. Such table thresholds 315, for example, each indicate an MLPH value that defines at least a portion of a range of MLPH values associated with a queue 320. For example, a first queue 320-1 is associated with a first range that includes MLPH values less than a first table threshold 315 indicating a first MLPH value (e.g., non-inclusive of the first table threshold 315); a second queue 320-2 is associated with a second range that includes MLPH values between the first table threshold 315 (e.g., inclusive of the first table threshold 315) and a second table threshold 315 indicating a second MLPH value greater than the first table threshold 315 (e.g., non-inclusive of the second table threshold 315); and a third queue 320-N is associated with a third range that includes MLPH values greater than the second table threshold 315 (e.g., inclusive of the second table threshold 315). Further, each queue 320 is defined by processor 102 such that each queue 320 is configured to provide embedding table threads 175 to certain processor cores 118 of one or more dies 116. For example, processor 102 defines a first queue 320-1 such that the first queue 320-1 is configured to provide embedding table threads 175 to one certain processor core (e.g., 118-1, 118-5, 118-9) of one or more dies 116 (e.g., e.g., dies 116-1, 116-2, 116-M). As another example, processor 102 defines a second queue 320-2 such that the second queue 320 is configured to provide embedding table threads 175 to three certain processor cores (e.g., 118-2, 118-3, 118-4, 118-6, 118-7, 118-8, 118-10, 118-11, 118-12) of one or more dies 116 (e.g., e.g., dies 116-1, 116-2, 116-M). In embodiments, processor 102 is configured to define queues 320 such that queues 320 associated with ranges including lower MLPH values are configured to provide embedding table threads 175 to a greater number of processor cores 118 per die 116 which, for example, enables embedding table threads 175 associated with embedding tables 125 of higher MLPHs 165 to be executed on a greater number of processor cores 118 which helps reduce processing times. Further, due to processor 102 defining the queues 320 such that one or more queues 320 are configured to provide embedding table threads 175 to one or more dies 116, a greater number of processor cores 118 per die 116 are enabled to be used at once to execute embedding table threads 175 which also helps reduce processing times.

Though the example embodiment presented in FIG. 3 shows processor 102 defining three queues (320-1, 320-2, 320-N) representing an N integer number of queues, in other embodiments, processor 102 is configured to define any non-zero integer number of queues 320. For example, processor 102 is configured to define any non-zero integer number of queues 320 each associated with a distinct range of MLPH values. Further, the example embodiment presented in FIG. 3 shows example architecture 300 as including three dies (116-1, 116-2, 116-M) representing an M integer number of dies that each include four processor cores (118-1, 118-2, 118-3, 118-4, 118-5, 118-6, 118-7, 118-8, 118-9, 118-10, 118-11, 118-12), in other embodiments, example architecture 300 includes any non-zero integer number of dies 116 each including any number of processor cores 118. In embodiments, two or more dies 116 include the same number of processor cores 118, two or more dies 116 include a different number of processor cores 118, or both.

To schedule one or more embedding table threads 175 (e.g., a set of embedding table threads 175 each associated with the same embedding table 125) within example architecture 300, processor 102 first determines the MLPH 165 of the embedding table 125 associated with the embedding table threads 175. Processor 102 then loads the embedding table threads 175 in the queue 320 associated with the range of MLPH values that includes the MLPH 165 of the embedding table 125 associated with the embedding table threads 175. From the queue 320, processor 102 provides the embedding table threads 175 to one or more processor cores 118 of one or more dies 116 to which the queue 320 is configured to provide embedding table threads 175 (e.g., as defined by processor 102). As an example, processor 102 provides the embedding table threads 175 to a number of processor cores 118 which the queue 320 is configured to provide embedding table threads 175 to equal to a number of processor cores indicated in the core grouping 217 of the embedding table 125 associated with the embedding table threads 175. As another example, processor provides the embedding table threads 175 to a number of available processor cores 118 to which the queue 320 is configured to provide embedding table threads 175.

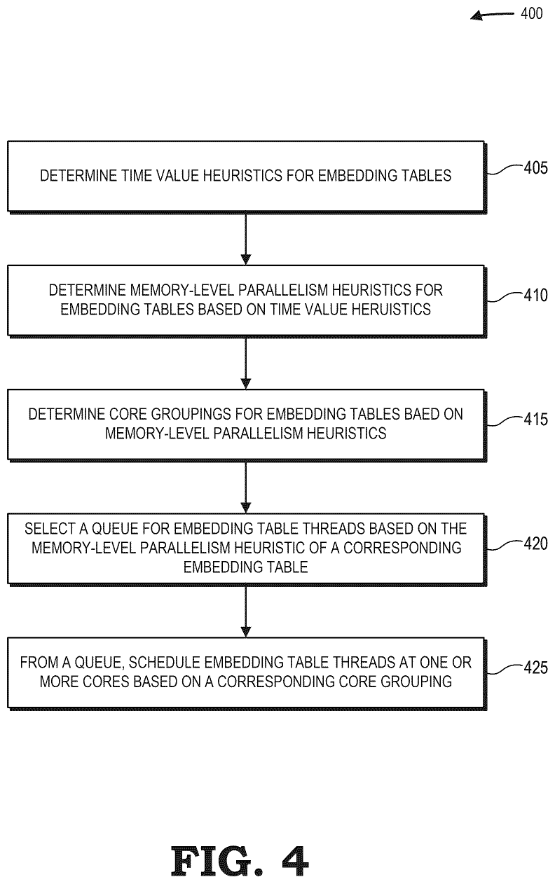

Referring now to FIG. 4, an example method 400 for hardware-aware thread scheduling to execute threads for embedding layers of a recommendation model is presented, in accordance with embodiments. In embodiments, at least a portion of example method 400 is implemented by processor 102 (e.g., one or more processor cores 118 of one or more dies 116 of processor 102). At block 405 of example method 400, processor 102 or another processing unit of a computing device (e.g., server, desktop computer, laptop computer) connected to processor 102 determines time value heuristics 155 for one or more embedding tables 125 of a recommendation model 135 to be implemented. During block 205, processor 102 or another processing unit first performs one or more inference batches and monitors the user pooling operations during these inference batches to determine a corresponding pooling factor 207 for each embedding table 125. Additionally, from these inference batches, processor 102 or another processing unit generates a reuse distance profile 211 for each embedding table 125 indicating, for example, an estimated reuse distance, estimated number of hits to a cache 120, estimated number of misses to the cache 120, or any combination thereof associated with a corresponding embedding table 125. Using the reuse distance profiles 211 of the embedding tables 125, processor 102 or another processing unit determines a respective AMAL 209 for each embedding table 125 that represents a ratio of the estimated hits to a cache 120 to the estimated misses to the cache 120 for the embedding table 125. Processor 102 or another processing unit then determines a corresponding time value heuristic 155 for each embedding table 125 based on the pooling factor 207 and AMAL 209 of the embedding table 125. For example, processor 102 or another processing unit multiplies the pooling factor 207 of an embedding table 125 by the AMAL 209 of the embedding table 125 to determine a time value heuristic 155 for the embedding table 125.

After determining a respective time value heuristic 155 for each embedding table 125, at block 410, processor 102 or another processing unit determines an MLPH 165 for each embedding table 125 based on the time value heuristics 155 of the embedding tables 125. As an example, to determine an MLPH 165 for an embedding table 125, processor 102 or another processing unit first determines a cache miss ratio 213 based on the reuse distance profile 211 of the embedding table 125. Processor 102 or another processing unit then multiplies this cache miss ratio 213 by the time value heuristic 155 of the embedding table 125 to determine the MLPH 165 of the embedding table 125. At block 415, in embodiments, processor 102 or another processing unit is configured to determine a respective core grouping 217 for one or more embedding tables 125 based on the MLPHs 165 of the tables. As an example, based on the MLPH 165 of an embedding table 125, processor 102 or another processing unit determines a core grouping 217 indicating a number of processor cores 118 that, when used to execute one or more embedding table threads 175 associated with the embedding table 125, helps processing system 100 meet one or more desired metrics (e.g., memory bandwidth, processing time, memory accesses). Processor 102 or another processing unit then includes the core grouping 217 in the embedding table 125 as metadata, a flag, or both.

After an MLPH 165, core grouping 217, or both is determined for one or more embedding tables 125, at block 420, processor 102 is configured to schedule embedding table threads 175 for execution based on the MLPHs 165 of the embedding tables 125. For example, to schedule the embedding table threads, processor 102 first defines one or more queues 320 (e.g., software queues) each associated with a range of MLPH values based on one or more table thresholds 315. Further, processor 102 defines these queues 320 such that each queue 320 is configured to provide embedding table threads 175 to one or more certain processor cores 118 of one or more dies 116. Processor 102 then schedules the embedding table threads 175 for execution using these queues 320. For example, to schedule one or more embedding table threads 175 associated with an embedding table 125 (e.g., a set of embedding table threads 175 that each access the same embedding table 125), processor 102 determines the MLPH 165 of the associated embedding table 125. Processor 102 then loads the embedding table threads 175 in the queue 320 associated with a range of MLPH values that includes the MLPH 165 of the associated embedding table 125. From the queue 320, at block 425, processor 102 provides the embedding table threads 175 to one or more processor cores 118 of one or more dies 116 which the queue 320 is configured to provide embedding table threads 175 to. For example, processor 102 provides the embedding table threads 175 to a number of processor cores 118 across one or more dies 116 to which the queue 320 is configured to provide embedding table threads 175 equal to the number of processor cores 118 indicated in the core group 217 of the associated embedding table 125. As another example, processor 102 provides the embedding table threads 175 to a number of available processor cores 118 across one or more dies 116 to which the queue 320 is configured to provide embedding table threads 175.

In some embodiments, the apparatus and techniques described above are implemented in a system including one or more integrated circuit (IC) devices (also referred to as integrated circuit packages or microchips), such as the processor 102 described above with reference to FIGS. 1-4. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is set forth in the claims below.

What is claimed is:

1. A method comprising:
select, by a processor, a queue from a plurality of queues for a set of threads of a recommendation model based on a heuristic value of an embedding table associated with the set of threads;
providing threads of the set of threads to a number of processor cores from the queue; and
executing, by the number of processor cores, the set of threads.

2. The method of claim 1, wherein the queue is associated with a range of heuristic values that includes the heuristic value of the embedding table associated with the set of threads.

3. The method of claim 2, wherein a second queue of the plurality of queues is associated with a second range of heuristic values that does not include the heuristic value of the embedding table associated with the set of threads.

4. The method of claim 1, further comprising:
determining a time value heuristic of the embedding table based on a pooling factor and a memory access latency associated with the embedding table.

5. The method of claim 4, further comprising:
determining a memory level parallelism heuristic of the embedding table based on the time value heuristic associated with the embedding table, wherein the heuristic value indicates the memory level parallelism heuristic of the embedding table.

6. The method of claim 1, further comprising:
identifying one or more embedding vectors in the embedding table based on executing the set of threads; and
determining a recommendation based on the one or more embedding vectors.

7. The method of claim 1, further comprising:
defining the queue such that the queue is configured to provide one or more threads to the number of processor cores.

8. A processor, comprising:
a plurality of processor cores, wherein one or more processor cores of the plurality of processor cores are configured to:
select a queue from a plurality of queues for a set of threads of a recommendation model based on a heuristic value of an embedding table associated with the set of threads; and
provide threads of the set of threads to a number of processor cores of the plurality of processor cores,
wherein the number of processor cores of the plurality of processor cores is configured to execute the set of threads.

9. The processor of claim 8, wherein the queue is associated with a range of heuristic values that includes the heuristic value of the embedding table associated with the set of threads.

10. The processor of claim 9, wherein a second queue of the plurality of queues is associated with a second range of heuristic values that does not include the heuristic value of the embedding table associated with the set of threads.

11. The processor of claim 8, wherein one or more processor cores of the plurality of processor cores are configured to:
define the queue such that the queue is configured to provide one or more threads to the number of processor cores of the plurality of processor cores.

12. The processor of claim 11, wherein the one or more processor cores of the plurality of processor cores are configured to:
define a second queue of the plurality of queues such that the second queue is configured to provide one or more threads to a second number of processor cores of the plurality of processor cores different from the number of processor cores.

13. The processor of claim 8, further comprising a plurality of dies each including one or more processor cores of the plurality of processor cores, wherein the number of processor cores is across two or more dies of the plurality of dies.

14. The processor of claim 13, wherein the one or more processor cores of the plurality of processor cores are configured to:
identify one or more embedding vectors in the embedding table based on executing the set of threads; and
determine a recommendation based on the one or more embedding vectors.

15. A processor, comprising:
a plurality of dies each including a plurality of processor cores, wherein one or more processor cores of one or more dies of the plurality of dies are configured to:
define a first queue associated with a first range of memory-level parallelism heuristic values;
define a second queue associated with a second range of memory-level parallelism heuristic values;
load a set of threads of a recommendation model into the first queue or the second queue based on a memory level parallelism heuristic of an embedding table associated with the set of threads; and
provide threads of the set of threads to one or more dies of the plurality of dies from the first queue or second queue,
wherein the one or more processor cores of the one or more dies are configured to execute the set of threads.

16. The processor of claim 15, wherein the one or more processor cores of the one or more dies are configured to:
based on the memory level parallelism heuristic of the embedding table being within the first range, load the set of threads to the first queue; and
based on the memory level parallelism heuristic of the embedding table being within the second range, load the set of threads to the second queue.

17. The processor of claim 15, wherein the first queue is configured to provide one or more threads to certain processor cores of each of one or more dies of the plurality of dies.

18. The processor of claim 17, wherein the second queue is configured to provide one or more threads to one or more other processor cores of each of one or more dies of the plurality of dies.

19. The processor of claim 15, wherein the memory level parallelism heuristic of the embedding table is based on a time value heuristic of the embedding table.

20. The processor of claim 19, wherein the time value heuristic is based on a pooling factor and memory access latency associated with the embedding table.
